(19) United States
(12) Patent Application Publication
(10) Pub. No.: US 2024/0166040 A1
(43) Pub. Date: May 23, 2024

(54) BATTERY PACKS FOR UTILITY VEHICLE ELECTRIC DRIVETRAINS

(71) Applicant: Hexagon Purus North America Holdings Inc., Costa Mesa, CA (US)

(72) Inventors: Eric M. Coupal-Sikes, Kelowna (CA); Landon Tyerman, Kelowna (CA); Sahir Singh Virk, Kelowna (CA); Ethan J. McKibben, Kelowna (CA); Todd F. Sloan, Kelowna (CA)

(21) Appl. No.: 18/425,754

(22) Filed: Jan. 29, 2024

Related U.S. Application Data
(63) Continuation of application No. PCT/US2022/040912, filed on Aug. 19, 2022.
(60) Provisional application No. 63/260,615, filed on Aug. 26, 2021.

(51) Int. Cl. B60K 1/04; B60L 50/64; H01M 50/204; H01M 50/242; H01M 50/249

(52) U.S. Cl. CPC B60K 1/04; B60L 50/64; H01M 50/204; H01M 50/242; H01M 50/249; B60K 2001/0438; H01M 2220/20

(57) ABSTRACT

A battery assembly is provided for an electric vehicle that include a housing, one or more battery units, and a connector. The housing has a forward side, a rearward side, a bottom side, and a top portion. The top portion is configured to project into a space between adjacent frame rails. The housing also has a lateral portion configured to extend under a bottom surface of one of the adjacent frame rails. The one or more battery units are disposed within the top portion of the housing. The connector disposed over the lateral portion of the housing. The connector being configured to releasably coupled with one of the adjacent frame rails.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 C.F.R. § 1.57.

### BACKGROUND

### Field of the Invention

This application is directed to battery packs or modules powering electric motors to propel vehicles, in particular for trucks and other utility vehicles of various types.

### Description of the Related Art

Electric vehicles have become more and more popular in recent years. This is particularly true among passenger vehicles. The use of electric motors and batteries to propel heavy and medium duty utility vehicles has been much less prevalent. Equipping utility vehicles such as these with well-designed electric drivetrains presents unique complexities.

### SUMMARY

There is a need for improved battery packs that can power utility vehicles with sufficient power storage while being applicable to stock vehicles. There is a need for battery assemblies that provide enhanced or greater storage while occupying a minimum of area best reserved for other vehicle equipment, such as a truck box, a beverage body, or other assemblies that may overhang a frame assembly or other chassis portion. Such battery assemblies preferably are transversely compact, e.g., by being substantially entirely disposed within the width of a frame assembly, at least at or just below the point of connection to the frame assembly.

In one example, a battery assembly for an electric vehicle is provided that include a housing, one or more battery units, and a connector. The housing has a forward side, a rearward side, a bottom side, and a top portion. The top portion is configured to project into a space between adjacent frame rails. The housing also has a lateral portion configured to extend under a bottom surface of one of the adjacent frame rails. The one or more battery units are disposed within the top portion of the housing. The connector is coupled with the housing. In one example, the connector is disposed over the lateral portion of the housing. The connector is configured to be releasably coupled with one of the adjacent frame rails.

In another example, a battery assembly for an electric vehicle is provided that includes a housing, one or more battery units, and a mounting system. The housing has a concave enclosure that has a forward side, a rearward side, a top portion and a bottom side. An access plate is coupled with the bottom side. The top portion has a first shoulder and a second shoulder. The first shoulder extends from a first lateral side of the concave enclosure toward a central portion of the concave enclosure. The first shoulder extends a first distance from the access plate (e.g., perpendicular to the access plate). The second shoulder extends from a second lateral side of the concave enclosure toward the central portion. The second shoulder extends a second distance perpendicular from the access plate (e.g., perpendicular to the access plate). The central portion extends from the first shoulder to the second shoulder. The central portion extends a third distance from the access plate (e.g., perpendicular to the access plate). The third distance is greater than the first distance and the second distance. The one or more battery units are disposed within the concave enclosure at an elevation above the first shoulder and an elevation above the second shoulder. The mounting system has a first portion disposed on the first shoulder and a second portion disposed on the second shoulder. The mounting system has a frame member bracket and a shoulder bracket system. The frame member bracket is configured to connect to a frame member of a vehicle. The shoulder bracket system has a load member, an aperture array and a vibration isolator. The load member has a first portion disposed over the first shoulder of the top portion of the concave enclosure and a second portion angled relative to the first portion. The second portion is disposed along a lateral side of the central portion. The aperture array is disposed along the first lateral side of the concave enclosure, e.g., at an outer edge of the first shoulder. The aperture array is configured to be coupled to the frame member bracket. The vibration isolator is disposed between the load member and a top surface of the first shoulder. The vibration isolator reduces load transmission from the frame member of the vehicle to the housing.

In one variation, the first and second distance are approximately the same. In another variation, the third distance is more than twice the first distance.

The battery assembly can have a relatively high aspect ratio, while being configured to be mounted below a vehicle frame assembly. In various configurations, an aspect ratio of the housing can exceed 0.5. The aspect ratio can be defined as a ratio of the third distance to a width defined in a horizontal plane perpendicular to the third distance and perpendicular to a longitudinal axis of a vehicle to which the battery assembly is configured to be coupled.

The battery assemblies disclosed herein can have a battery management module disposed on one of the forward side and the rearward side of the housing. The battery management module can be low profile, e.g., configured to extend under an element of a chassis, e.g., under a cross member disposed between adjacent frame rails.

In some cases, the aperture array can be disposed on a lateral extension of the load member. The lateral extension can include a connection portion coupling the first portion of the load member to the second portion of the load member. The lateral extension can include a frame member clearance portion disposed between the connection portion and the aperture array. The frame member clearance portion can enable a bottom portion of a frame member to at least partially be nested in the load member.

In some embodiments, the load member can include an elevated portion disposed between a first compressible member of the vibration isolator and a second compressible member of the vibration isolator. The elevated portion transferring a connection load to the first portion of the load member.

In another embodiment, a vehicle assembly is provided that includes a frame assembly and a battery assembly. The frame assembly includes a first frame rail that has an inner surface facing toward a central longitudinal axis of the frame assembly and an outer surface facing away from the central longitudinal axis of the frame assembly. The frame assembly further includes a second frame rail disposed on an opposite side of a central longitudinal axis of the frame assembly from the first frame rail. The second frame rail has an inner surface facing toward the central longitudinal axis of the frame assembly and an outer surface facing away from the central longitudinal axis of the frame assembly. The battery assembly has a housing, a first battery unit, a second battery unit, and a mounting system. The housing has a concave enclosure that has a central portion disposed between and projecting from adjacent shoulder portions. The first battery unit is disposed within the central portion. The second battery unit is disposed within one of the shoulder portions. The mounting system has a first frame member bracket, a second frame member bracket, and a shoulder bracket system. The first frame member bracket is coupled to the outer surface of the first frame rail. The second frame member bracket is coupled to the outer surface of the second frame rail. The shoulder bracket system has a first load member, a vibration isolator, and a first aperture array. The first load member has a first portion disposed over one of the adjacent shoulder portions and a second portion disposed along the central portion of the housing. The vibration isolator is disposed between the first load member and a top surface of the one of the adjacent shoulder portions. The first aperture array is disposed at or adjacent to a first lateral edge of the housing. The first aperture array is coupled with the first frame member bracket. The shoulder bracket assembly includes a second load member and a second aperture array. The second load member has a first portion disposed over the other of the adjacent shoulder portions and a second portion disposed along the central portion of the housing. A vibration isolator is disposed between the second load member and a top surface of the other of the adjacent shoulder portions. The second aperture array is disposed at or adjacent to a second lateral edge of the housing. The second aperture array is coupled with the second frame member bracket. The first battery unit is disposed between the first frame rail and the second frame rail. The second battery unit is disposed below the first frame rail and the second frame rail.

In one or more variations, the first lateral edge of the housing is disposed inboard of the outer surface of the first frame rail and the second lateral edge of the housing is disposed inboard of the outer surface of the second frame rail. Vehicle equipment is or are mounted to the first frame rail and/or the second frame rail at the same position along the longitudinal axis of the vehicle assembly as is the battery assembly. The frame assembly can include a first cross member coupling the first frame rail to the second frame rail and a second cross member coupling the first frame rail to the second frame rail. The first cross member is disposed forward of the second cross member. The battery assembly is disposed between the first cross-member and the second cross-member. In one vehicle assembly, a second battery assembly is coupled with the frame assembly forward of the first cross-member and between the inner surface of the first frame rail and the inner surface of the second frame rail. In a further variation, an axle drive assembly is coupled with the frame assembly rearward of the second cross-member and between the inner surface of the first frame rail and the inner surface of the second frame rail. In some vehicle assemblies, an accessory module is electrically coupled to the battery assembly and an axle drive assembly is coupled with the battery assembly. The accessory module and the axle drive assembly are powered by the same battery assembly.

Vehicle assemblies can be provided in which a power distribution assembly is disposed electrically between two or more of the battery assembly, the axle drive assembly, and the accessory module. A range extender module can be electrically coupled with the power distribution assembly. The range extender module can include a fuel cell.

In various vehicle assemblies, an aspect ratio can be defined as a ratio of a height of the housing of the battery assembly in a vertical direction to a width of the housing of the battery assembly in a horizontal direction transverse to the central longitudinal axis of the frame assembly exceeds 0.5.

### BRIEF DESCRIPTION OF THE DRAWINGS

Features of the invention can be better understood from the following detailed description when read in conjunction with the accompanying schematic drawings, which are for illustrative purposes only. The drawings include the following figures:

FIG. 1 is a side and rear perspective view of a vehicle assembly including an electric drivetrain system having a transversely compact battery assembly;

FIGS. 2-3 are perspective and top views of the vehicle assembly of FIG. 1 with an assembly enclosing a cab removed;

FIG. 4 is a bottom view of the vehicle assembly of FIG. 1;

FIG. 5 shows components of one embodiment of an electric drivetrain system separated from a frame assembly of the vehicle assembly of FIG. 1;

FIG. 5A is a schematic diagram of the electric drivetrain system of FIG. 5 according to one example;

FIG. 6 is a rear perspective view of a sub-assembly of the vehicle assembly shown in FIG. 1 illustrating the positioning of a battery assembly;

FIGS. 7A-7D show views of one example of a battery assembly and components thereof;

FIGS. 8-8D illustrate aspects of connectors and a mounting system of the battery assembly of FIGS. 7A-7D; and

FIGS. 9-10 show additional embodiments of a battery assembly mounted in a different matter to a frame assembly of a vehicle assembly.

### DETAILED DESCRIPTION

While the present description sets forth specific details of various embodiments, it will be appreciated that the description is illustrative only and should not be construed in any way as limiting. Furthermore, various applications of such embodiments and modifications thereto, which may occur to those who are skilled in the art, are also encompassed by the general concepts described herein. Each and every feature described herein, and each and every combination of two or more of such features, is included within the scope of the present invention provided that the features included in such a combination are not mutually inconsistent.

This application discloses advantageous battery pack configurations with transversely compact configurations, but which still have sufficient capacity to power utility vehicles, such as box trucks, refrigerator trucks and other Class 5 and 6 trucks, as well as vehicles of other sizes and configurations.

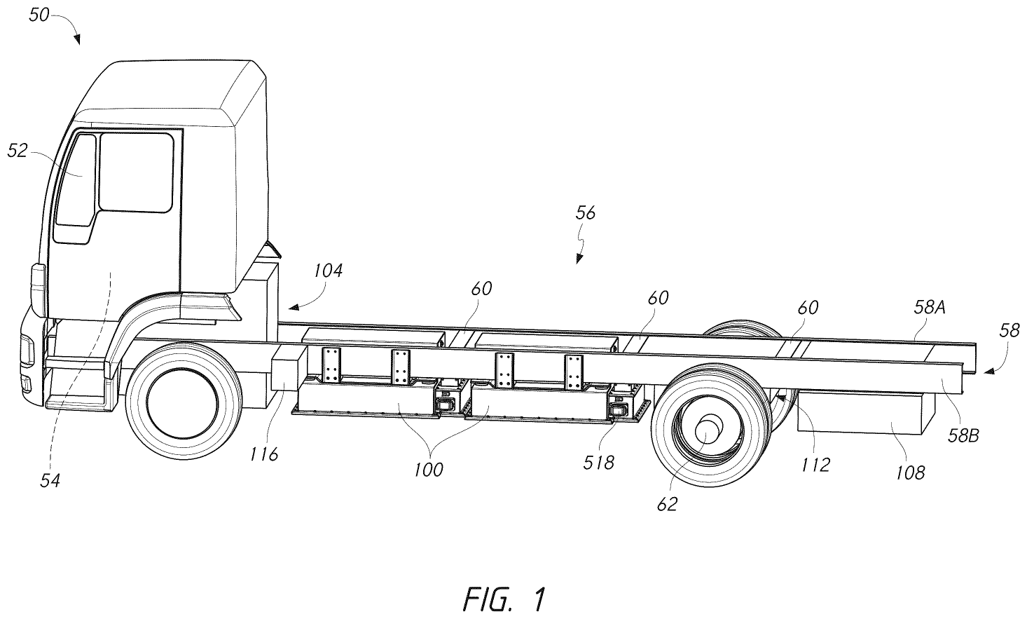

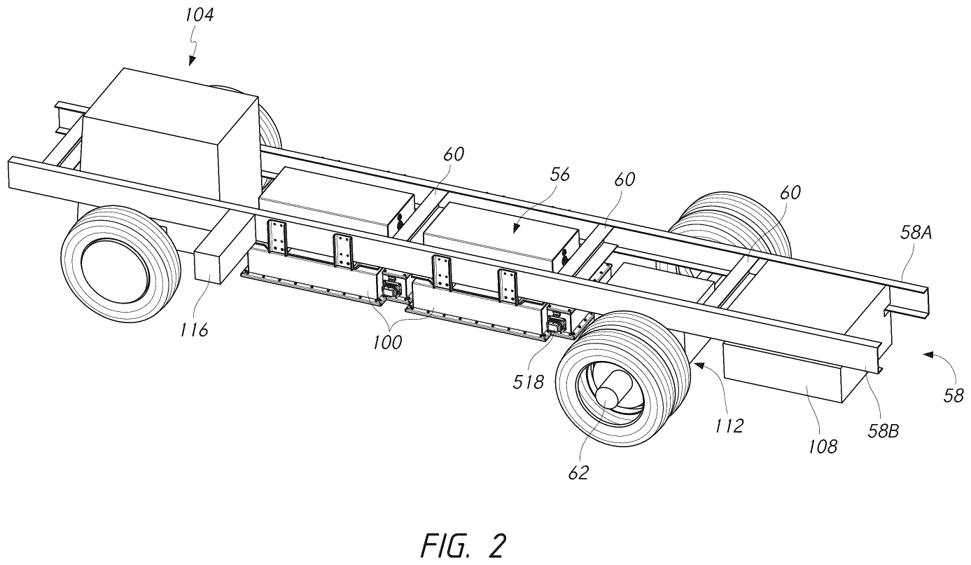

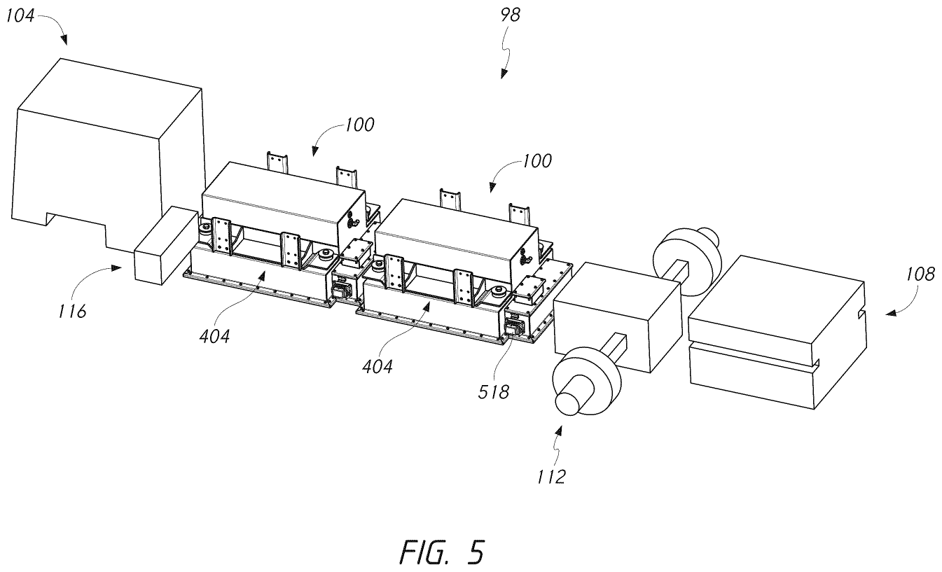

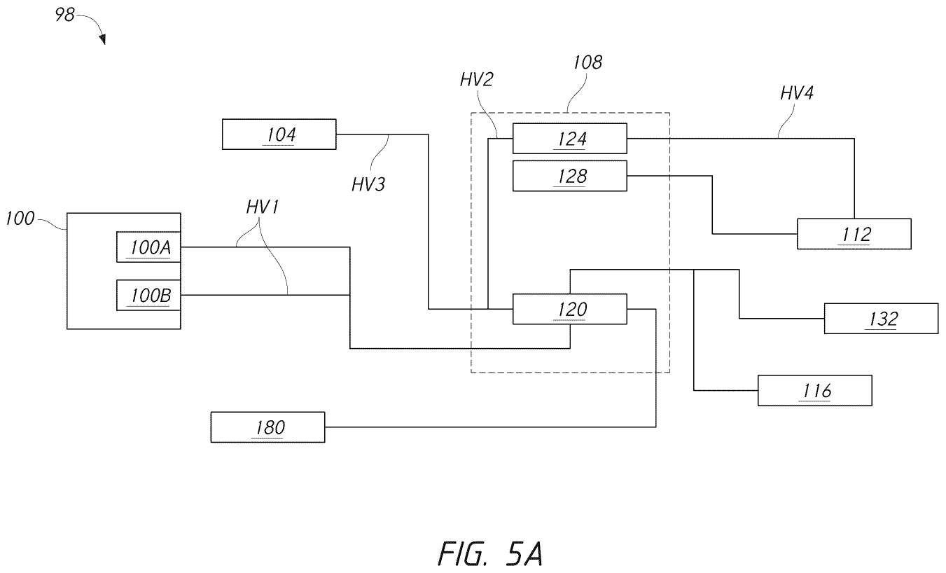

FIG. 1 shows a vehicle assembly 50 that includes a cab 52 disposed adjacent to, e.g., above and in some cases extending ahead of a front end compartment 54. The cab 52 also can be supported by a frame assembly 56 including frame rails 58, e.g., a frame rail 58A and a frame rail 58B. The frame assembly 56 also can support an axle 62. The axle 62 is rotatably supported and also supports wheels to drive the vehicle assembly 50 during operation thereof. The vehicle assembly 50 can be a stock vehicle. The vehicle assembly 50 can be one that was initially designed for or can be alternatively incorporated into a vehicle with an internal combustion engine. The vehicle assembly 50 can be modified to include an electric drivetrain system 98. The electric drivetrain system 98 is described below separate from the vehicle assembly 50 in connection with FIGS. 5-5A.

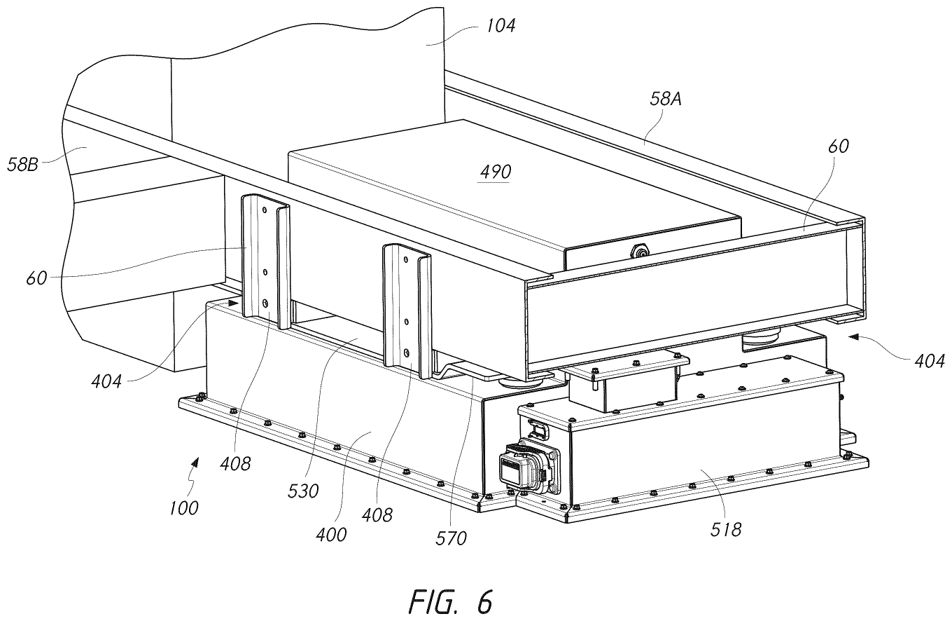

The frame assembly 56 also can include one or more cross members 60 that connect the frame rail 58A to the frame rail 58B. The cross members 60 can be disposed forward and rearward of the axle 62. The cross members 60 can be positioned between front and rear wheels of the vehicle assembly 50. The cross members 60 can separate the frame assembly 56 into two, three, four, five, six or more than six sections separating different components of the electric drivetrain system 98. The cross members 60 can be mounted toward the top of the frame rails 58A, 58B leaving some clearance for components of the battery assembly 100 as shown in FIG. 6.

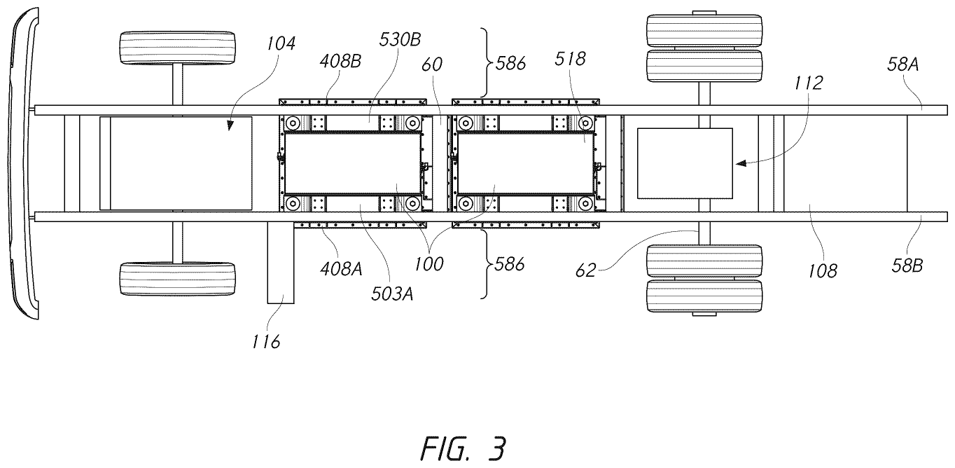

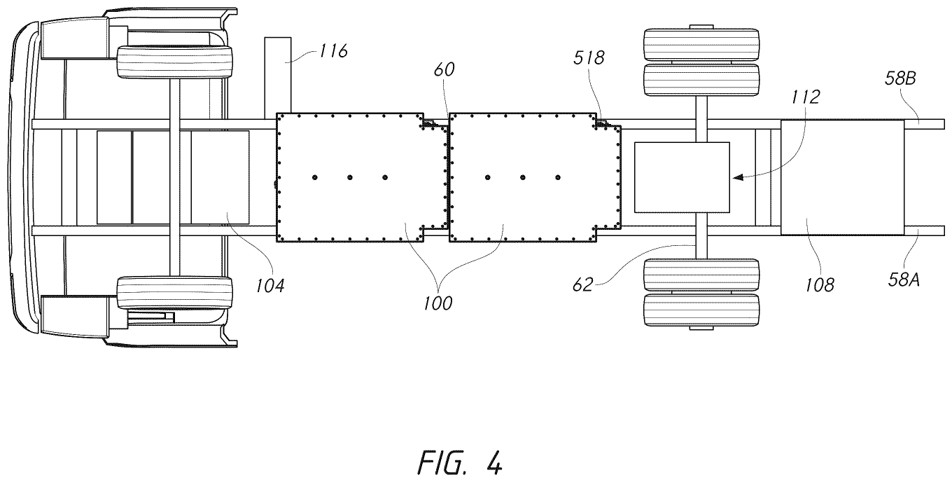

The electric drivetrain system 98 can include one or more, e.g., two battery assemblies 100. The battery assembly 100 is a source of electrical power of the vehicle assembly 50 that can support operation of one or more loads thereof. The electric drivetrain system 98 can include an axle drive assembly 112 as one example of a load to be powered by the battery assembly 100. The axle drive assembly 112 can be directly coupled to the axle 62, as shown in FIG. 3. The electric drivetrain system 98 can include a front end accessory component assembly 104 as another example of a load to be powered by the battery assembly 100. In various examples, the battery assembly 100 powers the front end accessory component assembly 104 and the axle drive assembly 112 concurrently. The electric drivetrain system 98 can be controlled by a power distribution assembly 108 that can be mounted in any convenient location on the vehicle assembly 50, e.g., in any available space between the frame rail 58A and the frame rail 58B. The power distribution assembly 108 can be mounted behind the axle 62. The power distribution assembly 108 can be mounted forward of the axle drive assembly 112 in one variation. The electric drivetrain system 98 can include an electric motor that is mounted away from, e.g., forward of, the axle 62. In such embodiments, the electric motor can rotate a transmission shaft to indirectly rotate the axle 62.

FIG. 5A shows one way of controlling the flow of electrical power in the electric drivetrain system 98. The battery assembly 100 can include one or more than one assembly of battery cells, e.g., a first battery cell assembly 100A and a second battery cell assembly 100B. The first battery cell assembly 100A and the second battery cell assembly 100B can be coupled independently to the power distribution assembly 108 via dedicated high voltage cables HV1. The power distribution assembly 108 can include a power distribution unit 120 configured to couple with the high voltage cables HV1 at a cable junction thereof. The power distribution unit 120 includes circuits (e.g., fuses, contactors, and controllers) to control the flow of current between the battery units of the battery assembly 100 and loads of the electric drivetrain system 98. The power distribution unit 120 outputs current via a high voltage cable HV2 to an inverter 124. The inverter 124 is configured to change the high voltage DC current flowing through the high voltage cables HV2 to three phase high voltage power in the high voltage cables HV4. Three phase high voltage power is used by the axle drive assembly 112 to propel the vehicle assembly 50. Thus, the inverter 124 outputs three phase high voltage current via high voltage cable HV4 to the axle drive assembly 112. The operation of the axle drive assembly 112 is controlled by a powertrain control circuit 128 disposed in the power distribution assembly 108. The power distribution unit 120 is coupled with a range extender module 132, which can include a fuel cell, additional batteries or other components to generate current to be used to recharge the battery assembly 100. The range extender module 132 can be disposed in the power distribution assembly 108 or in a separate location on the vehicle assembly 50.

The electric drivetrain system 98 can include a charge receptacle 116. The charge receptacle 116 can be connected to a high voltage DC power supply to direct current to the power distribution unit 120 and thereby to the battery assembly 100 or battery assemblies 100. The charge receptacle 116 can include a low voltage AC power connection. The power distribution assembly 108 can include (either in the power distribution unit 120 or in a separate component) a charge circuit configured to intake AC power and to generate DC power to charge the first battery cell assembly 100A and/or the second battery cell assembly 100B.

One or more components of the electric drivetrain system 98 can be operated by a vehicle control unit 180, which can be used to control the operation of the axle drive assembly 112, the power distribution unit 120, the inverter 124, powertrain control circuit 128, the range extender module 132, and/or other electrical components of the electric drivetrain system 98. The vehicle control unit 180 also can control components on the front end accessory component assembly 104 in various configurations. The vehicle control unit 180 can be coupled with the front end accessory component assembly 104 directly or by way of the power distribution unit 120. The front end accessory component assembly 104 can be coupled with the battery assembly 100 by way of the power distribution assembly 108, e.g., by way of the power distribution unit 120. High voltage cables HV3 can be coupled with and between the power distribution unit 120 and the front end accessory component assembly 104. The front end accessory component assembly 104 also could be directly connected to the battery assembly 100 in some embodiments.

The front end accessory component assembly 104 can include coolant pumps and loops, air compressors, inverters for low voltage operation, and other components to facilitate connecting components of multiple vehicle subsystems to the frame assembly 56 of the vehicle assembly 50 at one location and as a unit. Additional aspects of the front end accessory component assembly 104 are described in PCT/US2020/028859, which published as WO2020/215023, and which is incorporated by reference herein in its entirety to supplement the disclosure of the front end accessory component assembly 104, to supplement the disclosure of routing and protecting high voltage cables, and to supplement variations on the power distribution assembly 108, and for all other purposes as well. The power distribution assembly 108 can have any of the configurations disclosed in US63/260,601 (applicant's docket number HEX.023PR, titled POWER DISTRIBUTION MODULES FOR ELECTRIC DRIVETRAINS, which is incorporated by reference herein in its entirety).

FIG. 6 shows some details of the connection of the battery assembly 100 and the connection thereof to the frame assembly 56, e.g., to the frame rail 58A and the frame rail 58B. In one embodiment, a forward section of the frame assembly 56 includes a forward cross member 60 and a portion of the span of the frame rail 58A and the frame rail 58B (collectively the frame rails 58). The forward section can be located immediately rearward of the front end compartment 54, where the front end accessory component assembly 104 can be mounted. The forward section can include an available space between the frame rails 58. The frame assembly 56 is sufficiently rigid without additional supports between the frame rails 58 such that a space is available to accommodate a portion of the battery assembly 100. The battery assembly 100 can have a generally inverted-T shape, as discussed further below. A central portion 490 of a housing 400 of the battery assembly 100 can be positioned between the frame rails 58, as seen in FIG. 6. The battery assembly 100 can be supported by frame member brackets 408 on an outward facing side of the frame rails 58. A lower portion of the battery assembly 100 can include lateral portions that extend to but generally not outward of the outward facing sides of the frame rails 58. As discussed further below, this configuration locates the battery assembly 100 generally between the outward facing sides of the frame rail 58A and the frame rail 58B. In some cases, the battery assembly 100 includes a concave enclosure 450 and an access plate 470. At least an upper portion of, and in some cases the entirety of, the concave enclosure 450 will have a maximum width not exceeding the distance between the outward facing sides of the frame rails 58. The access plate 470 may be part of an assembly at the bottom of the battery assembly 100 that may extend outward of the frame rails 58. However, the portions of the battery assembly 100 near the frame assembly 56 are kept low profile to leave an area for other vehicle equipment unobstructed. The battery assembly 100 can be configured such that the battery assembly 100 does not extend into adjacent spaces of the vehicle assembly 50 where other vehicle equipment may be located or may need to be positioned. FIG. 6 thus shows that the battery assembly 100 provides ample volume for battery units without impairing the ability of the vehicle assembly 50 to accommodate such equipment along outer edges of the frame assembly 56.

As discussed more fully below, the frame member brackets 408 can form part of a mounting system 404 that includes components coupled with a top portion of the housing 400 of the battery assembly 100. The mounting system 404 can include components that couple with a top surface of the housing 400 outward of the central portion 490, e.g., with a first lateral side 486, a second lateral side 502 or of both lateral sides of the housing 400.

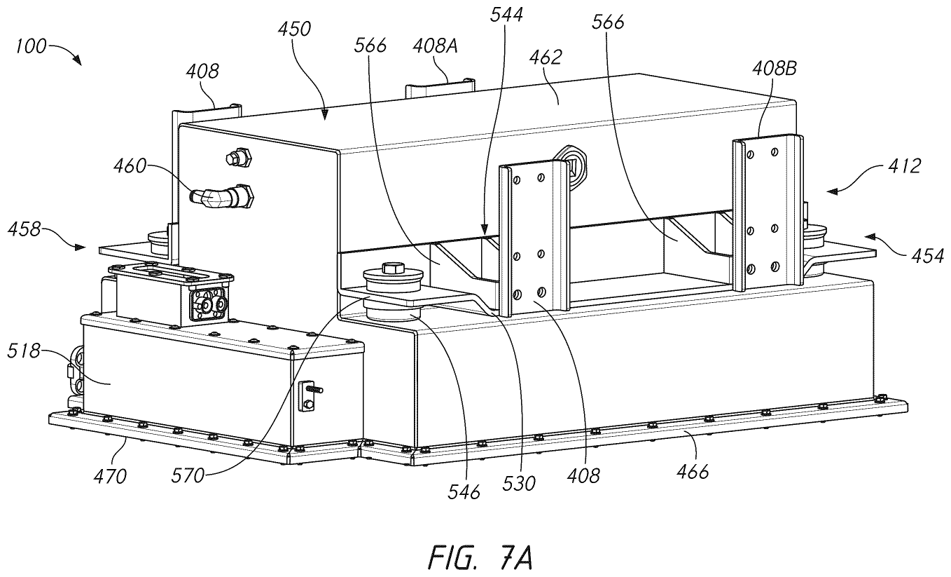

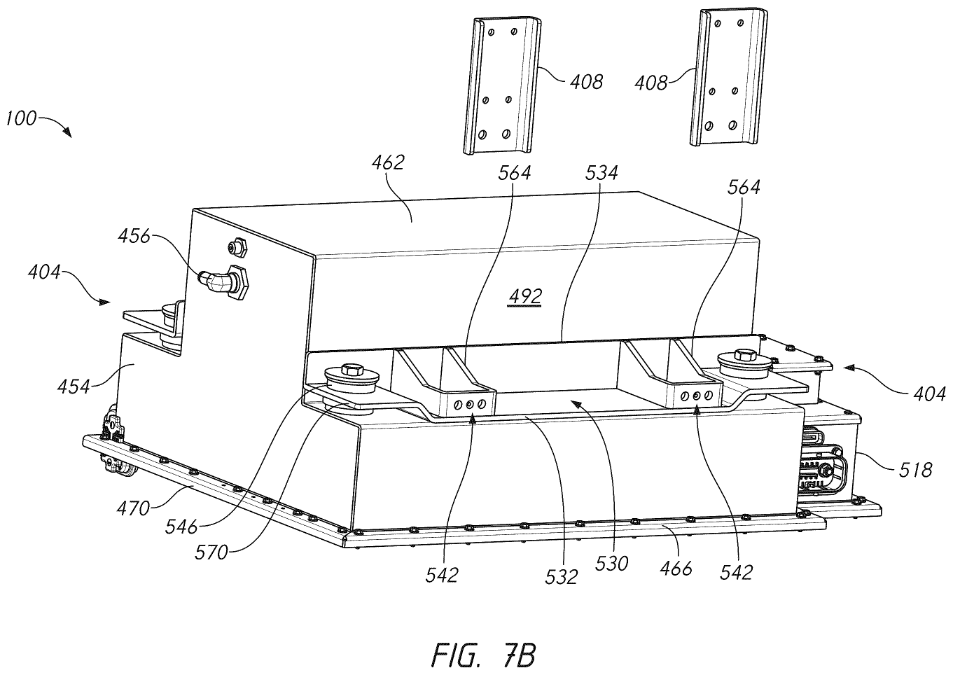

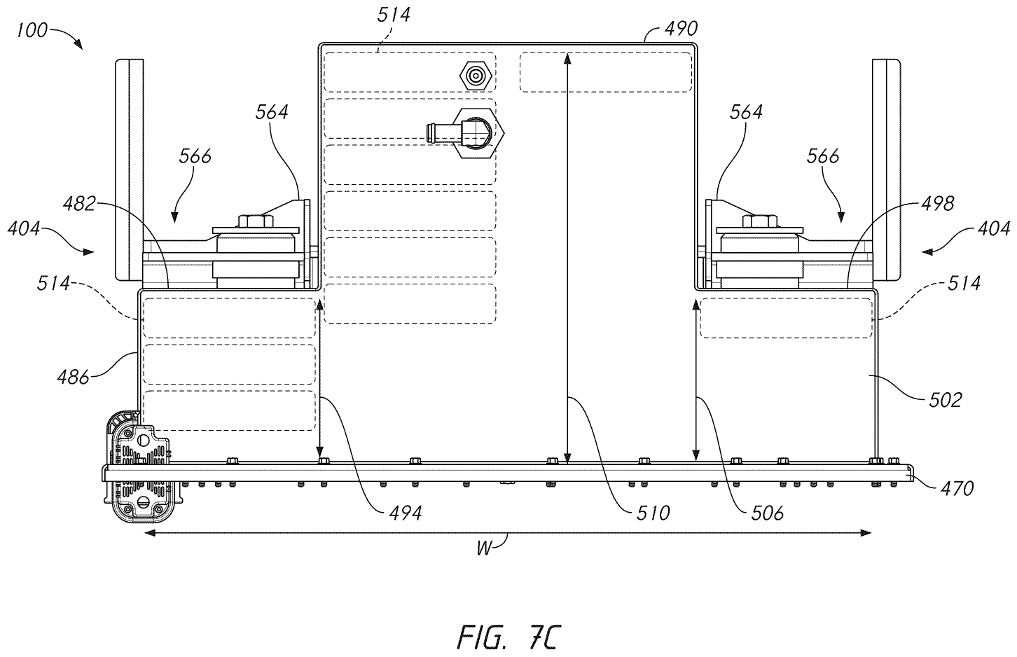

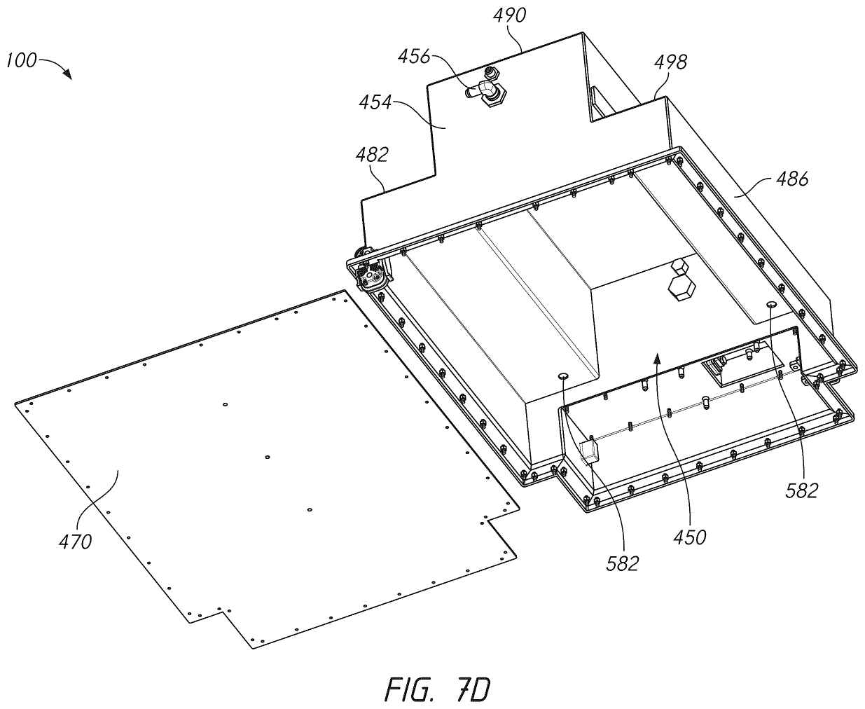

FIGS. 7A-7D show the battery assembly 100 in more detail. The battery assembly 100 includes a housing 400 that has a shoulder bracket system 412. The shoulder bracket system 412 when combined with the frame member brackets 408 can form the mounting system 404 in various examples. The battery assembly 100 can employ four (or more) frame member brackets 408. A first frame member bracket 408A can be disposed on a forward, driver side of the battery assembly 100 when the battery assembly 100 is attached to a vehicle. A second frame member bracket 408B can be disposed on a forward, rider side of the battery assembly 100 when the battery assembly 100 is attached to a vehicle. FIG. 7A shows that a third frame member bracket 408 can be disposed on driver side of the battery assembly 100 and the fourth frame member bracket 408 can be disposed on a rider side of the vehicle when the battery assembly 100 is attached to a vehicle. The frame member brackets 408 and the shoulder bracket system 412 enable the housing 400 to be secured to the vehicle in a low profile manner as described further below.

FIGS. 7A and 7D show that the housing 400 can include a concave enclosure 450 and the access plate 470. The concave enclosure 450 and the access plate 470 can fully enclose a volume that is used to contain battery units 514 (see FIG. 7C). The battery units 514 can be self-contained battery cells or self-contained arrays of battery cells. A plurality of such cells or units can be combined to provide the first battery cell assembly 100A or the second battery cell assembly 100B. FIG. 7D shows that the enclosed volume can be greater in a central area as discussed further below. The housing 400 can include a forward side 454, a rearward side 458, a top portion 462 and a bottom side 466. The forward side 454 can be generally flat. However, one or more coolant ports 456 (see FIG. 7B) can be provided on the forward side 454. The rearward side 458 can include a battery management module 518 section projecting therefrom. The rearward side 458 can include a coolant port 460 disposed thereon. The coolant port 460 can be disposed on an upper portion of the rearward side 458. The battery management module 518 can be disposed on a lower portion of the rearward side 458. The battery management module 518 can include electronic components or electronics used to control the flow of current to and from the first battery cell assembly 100A and the second battery cell assembly 100B, and can control how and when energy stores are drawn from each assembly. FIG. 7D shows that the battery management module 518 can be at least partially disposed in a volume that is continuous with and not divided from an area provided for enclosing the battery units 514.

The access plate 470 can be removable from the top portion 462 at the bottom side 466 to provide access to the enclosed volume. This can be done without removing the battery assembly 100 from the vehicle assembly 50, if desired. Such access can be for purposes of servicing and replacing the battery units 514. The top portion 462 can extend from a top surface of the housing 400 down to the bottom side 466. The top portion 462 can include side surfaces that extend from a first upper surface, e.g., a top surface, of the top portion 462 to the bottom side 466. The side surfaces can include two vertical portions, an upper vertical portion and a lower vertical portion. These vertical portions can be spaced apart horizontally by a second upper surface. The second upper surface can be disposed at a lower elevation than the first upper surface. In one example, a first lateral portion of the housing 400 can form a first shoulder 482 of the battery assembly 100. Also, a second lateral portion of the housing 400 can form a second shoulder 498 of the battery assembly 100.

When viewed from the front or the back, the housing 400 has a first shoulder 482, a second shoulder 498, and a central portion 490 between outer lateral sides of the housing 400, e.g., of the concave enclosure 450 of the housing 400. The first shoulder 482 can extend horizontally between a top surface of the central portion 490 and a first lateral side 486 of the housing 400. The second shoulder 498 can extend horizontally between the top surface of the central portion 490 and the second lateral side 502. The first shoulder 482 and the second shoulder 498 provide low profile lateral portions that facilitate the battery assembly 100 being underslung, e.g., mountable to and extending beneath the frame rails of a vehicle. The low profile lateral portions also allow the shoulder bracket system 412 to be positioned at least partially under the frame rails. The first shoulder 482 defines a first distance 494 between the access plate 470 and a top surface 484 of the first shoulder 482. The second shoulder 498 defines a second distance 506 disposed between the access plate 470 and a top surface of the second shoulder 498. The central portion 490 defines a third distance 510 between the access plate 470 and the top surface of the central portion 490. The first distance 494, the second distance 506 and the third distance 510 each extend perpendicularly to the access plate 470. The third distance 510 is more than the first distance 494. The third distance 510 is more than the second distance 506. The first distance 494 and the second distance 506 can be substantially equal to each other. In other embodiments, the first distance 494 and the second distance 506 are different. The specific values of the first distance 494 and the second distance may be based on numerous factors, including geometry of other aspects of the vehicle or the presence of other components of the vehicle. The third distance 510 can be more than, e.g., double or more than double the first distance 494. The third distance 510 can be more than, e.g., double or more than double the second distance 506.

The third distance 510 can correspond to the overall height (e.g., the largest vertical dimension) of the battery assembly 100. In some embodiments, the battery assembly 100 has a high aspect ratio, e.g., a high ratio of the third distance 510 to the width W of the housing 400. The aspect ratio can be greater than 0.5 in some embodiments, in other embodiments the aspect ratio can be greater than 0.25, 0.75, 1.0 or any range having any of the foregoing ratios as end points.

FIG. 7C shows that the third distance 510, which corresponds to a depth of the concave space of the concave enclosure 450 can enable a number of battery units 514 to be disposed at a higher elevation than the highest elevation of any of the battery units 514 disposed within the housing 400 beneath the first shoulder 482 or beneath the second shoulder 498. A battery stack disposed in the central portion 490 can have more than twice as many battery units 514 than a corresponding stack of battery units 514 between the central portion 490 and the first lateral side 486 (e.g., beneath first shoulder 482) and/or between the central portion 490 and the second lateral side 502 (e.g., beneath the second shoulder 498). A portion of the central portion 490 that is at an elevation higher than the top surface 484 of the first shoulder 482 or the second shoulder 498 can be configured to house more battery units 514 than can be housed beneath either the first shoulder 482 or the second shoulder 498.

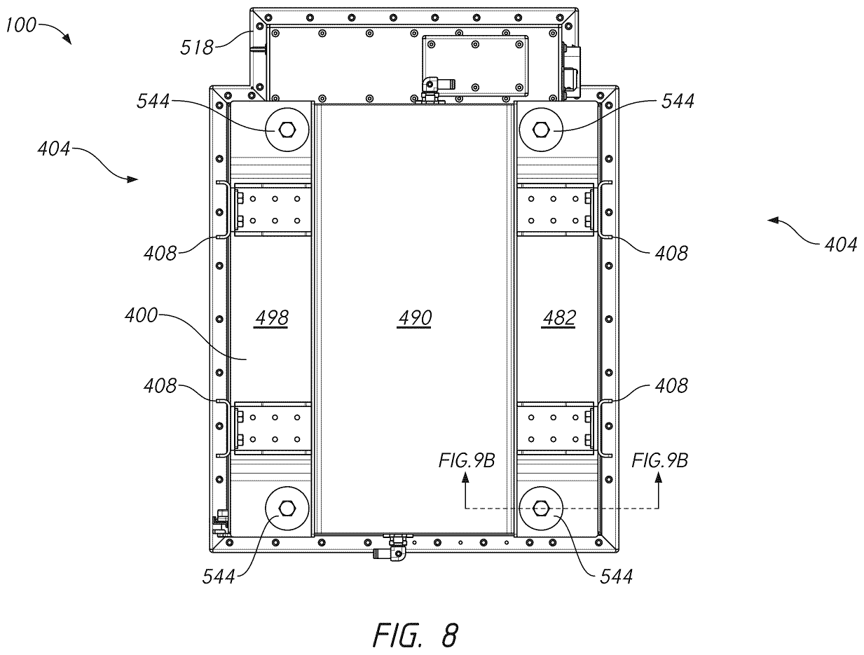

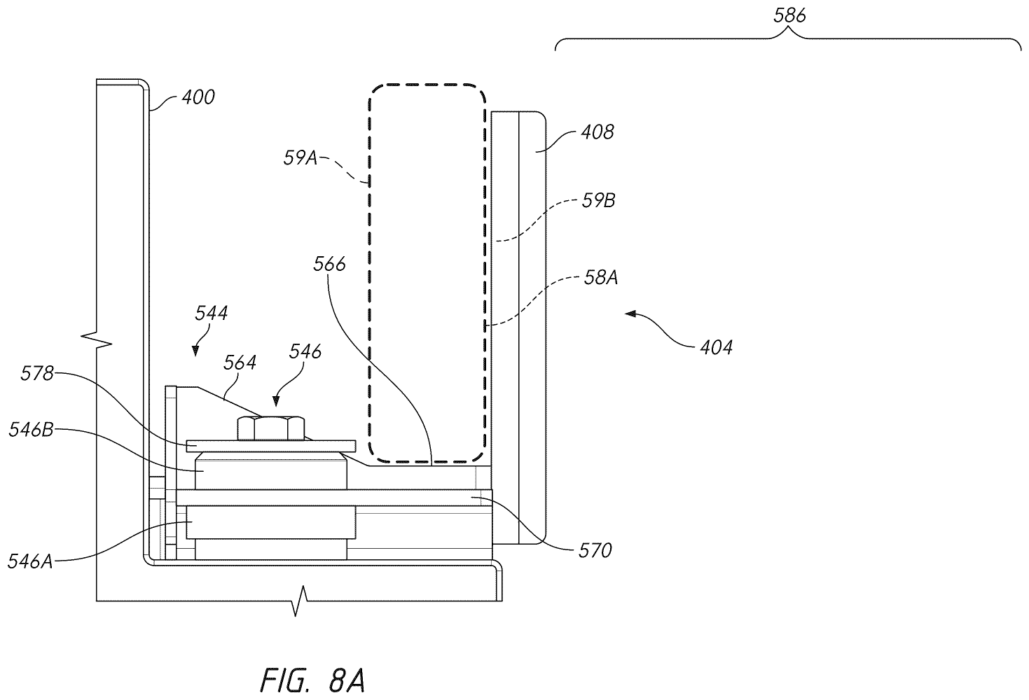

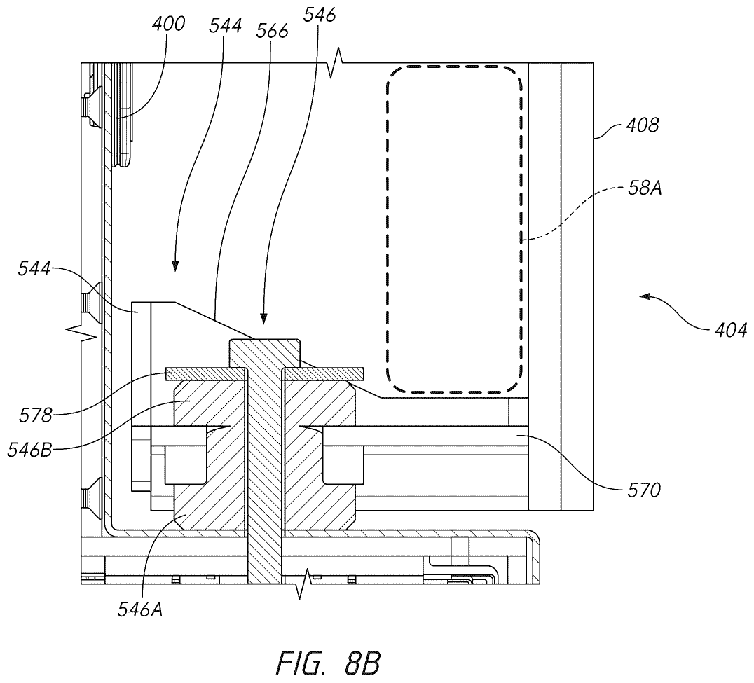

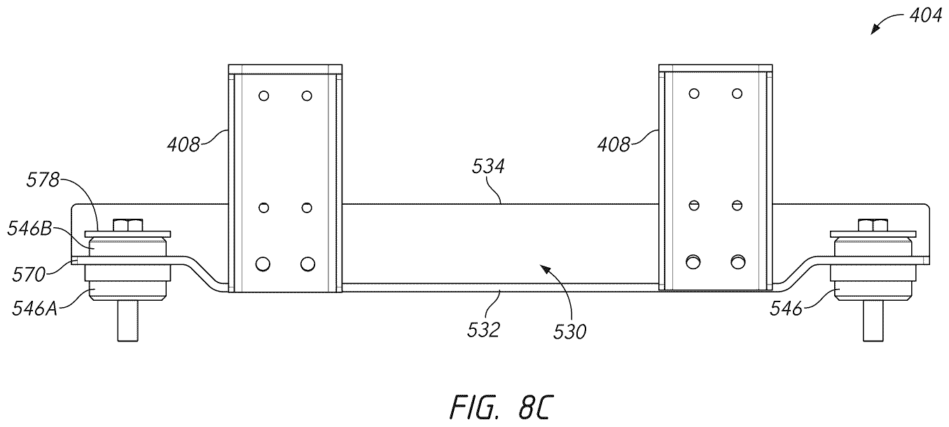

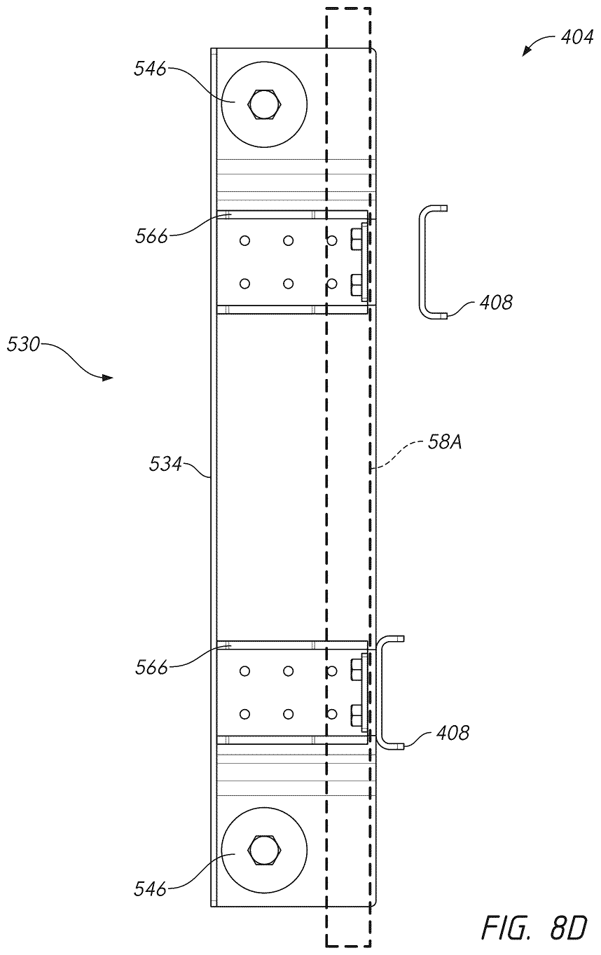

FIGS. 7A and 7B show features of the shoulder bracket system 412. FIG. 7B shows the frame member brackets 408 separated from the shoulder bracket system 412. The shoulder bracket system 412 includes a load member 530. The load member 530 can form part of a connector to connect the battery assembly 100 to the frame assembly 56 of the vehicle assembly 50. The load member 530 includes a first portion 532 and a second portion 534. The first portion 532 is disposed over the first shoulder 482, e.g., spaced apart from and/or in contact with the top surface 484 of the first shoulder 482. The second portion 534 can be angled relative to the first portion 532. The second portion 534 can be disposed at a ninety degree angle to the first portion 532. The second portion 534 can be disposed along the lateral side 492, e.g., spaced from and/or in contact with, of the central portion 490. FIG. 7C shows that the second portion 534 can be spaced apart from the lateral side 492 by a small distance. In some embodiments, the second portion 534 can be connected to the lateral side 492. The load member 530 can extend the entire length of the housing 400 from the forward side 454 to the rearward side 458. The load member 530 can extend from the lateral side 492 to the lateral side of the housing 400. FIG. 8 shows that in one example one load member 530 covers the entire first shoulder 482 and one load member 530 covers the entire second shoulder 498.

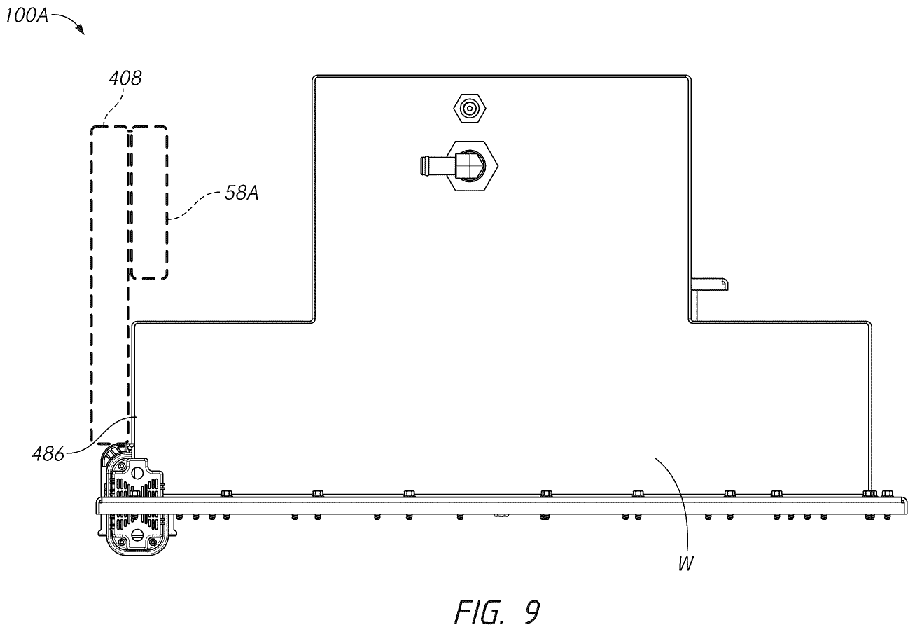

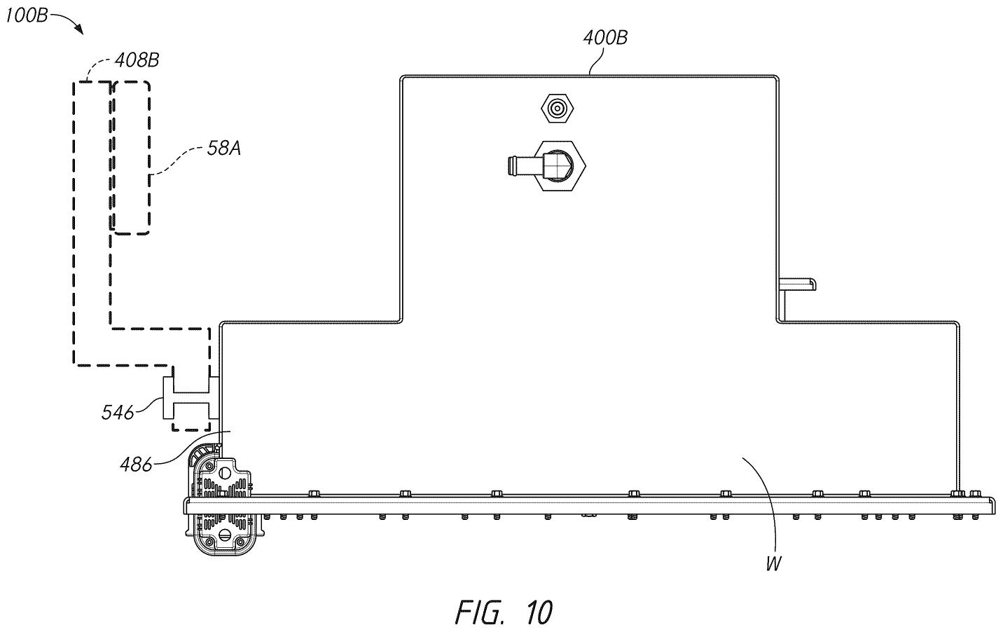

The housing 400 can be supported in other ways. For example, a bracket system including a modified frame member bracket 408 can be coupled with another side or surface of the housing 400 as shown in connection with a battery assembly 100B as shown in FIG. 9. A load member similar to the load member 530 discussed in connection with the battery assembly 100) can be mounted to the first lateral side 486 of the battery assembly 100A. A load member 530 can be mounted to the second lateral side 502 of the battery assembly 100A. A load member 530 can be mounted to a top of the central portion 490 of the battery assembly 100A. In some cases, the width W of the housing 400 can be less and a vibration isolator 546 can be mounted between the frame assembly 56 of the vehicle assembly 50, e.g., the frame rail 58A, and a side surface of the housing 400B, e.g., the first lateral side 486 or another surface of the housing 400 as shown in connection with the battery assembly 100B of FIG. 10. The battery assembly 100B may be a narrower configuration, e.g., having a housing 400B with a smaller width W. The battery assembly 100B can be mounted with a frame member bracket 408B having a transverse projection allowing the connection portion of the frame member bracket 408B to be outward of the outer surface of the housing 400B.

Connection of the frame member bracket 408 to the load member 530 can be achieved in any suitable manner In one embodiment the shoulder bracket system 412 includes an aperture array 542 disposed at a lateral edge thereof. The aperture array 542 can be disposed on a lateral extension 544 of the load member 530. The aperture array 542 can be coupled with the frame member bracket 408 to secure the battery assembly 100 to the frame assembly 56. The lateral extension 544 can comprise a U-shaped member coupled with a top surface of the first portion 532 and with an outward facing side of the second portion 534.

The shoulder bracket system 412 incorporates a vibration isolator 546 to reduce the effect of vibration or impact from the road to the vehicle assembly 50 applied to or on the battery assembly 100. The vibration isolator 546 can be integrated into the connection of the shoulder bracket system 412 to the housing 400. The vibration isolator 546 can be disposed between the first portion 532 of the load member 530 and the top surface 484 of the first shoulder 482 of the housing 400. FIG. 8A shows that the vibration isolator 546 can have a first compressible member 546A disposed between an elevated portion 570 of the first portion 532 and the top surface 484 of the first shoulder 482 of the housing 400. The first compressible member 546A can have a first side contacting the top surface 484 and a second side contacting a bottom surface of the elevated portion 570. The vibration isolator 546 can have a second compressible member 546B disposed between the elevated portion 570 and a fastener assembly 574. The fastener assembly 574 can include a compression disk 578 disposed over and in contact with a top surface of the second compressible member 546B.

Tightening of a bolt disposed through the vibration isolator 546 and through one of a plurality of fastening holes 582 in the housing 400 causes securing of the shoulder bracket system 412 to the top surface 484. Such securing may be accomplished without the load member 530 contacting the top surface 484 in some embodiments. The shoulder bracket system 412 can be secured to the housing 400 while maintaining a gap between the first portion 532 and the top surface 484 and between the second portion 534 and the lateral side 492 of the central portion 490. In some variations, the only point of contact between the shoulder bracket system 412 and the housing 400 is the fastener assembly 574 and the vibration isolator 546.

The load member 530 can be made stiffer by providing a connection portion 564 disposed between and connecting the first portion 532 to the second portion 534. The connection portion 564 can be disposed at a ninety degree angle to the first portion 532. The connection portion 564 can be disposed at a ninety degree angle to the second portion 534. The connection portion 564 can be disposed at a ninety degree angle to the first portion 532 and to the second portion 534. In one embodiment, the connection portion 564 extends from the second portion 534 to the aperture array 542 at a first location and from the aperture array 542 to the second portion 534 at a second location rearward of the first location. The connection portion 564 can have a U-shaped configuration as viewed from the top. The connection portion 564 can be tapered vertically or in elevation outwardly or laterally such that the outer portion thereof comprises a clearance portion 566. The clearance portion 566 has a lower profile, e.g., a lower elevation, than the connection portion 564 disposed inward thereof. The clearance portion 566 provides additional space of the frame rail 58A to be nested into the area above the first shoulder 482. The clearance portion 566 allows the central portion 490 to extend higher into the central area of the frame assembly 56. When the frame rail 58A is nested into the clearance portion 566, the inner surface 59A of the frame rail 58A faces in a direction toward a central vertical plane CP or central longitudinal axis of the frame assembly 56 and the outer surface 59B face away therefrom. The inner surface 59A can face the lateral side 492 of the central portion 490 when so nested. The outer surface 59B can be coupled to the inner surface of the frame member bracket 408. As a result, the battery assembly 100 is substantially retained inward of the frame rail 58A, or between the frame rail 58A and the frame rail 58B. This configuration allows a vehicle equipment area 586 to be maintained open. The vehicle equipment area 586 can be free of any portion of the battery assembly 100. FIG. 3 shows the vehicle assembly 50 equipped with the battery assembly 100 having the vehicle equipment area 586 substantially unobstructed by the battery assembly 100. FIG. 3 shows that the vehicle equipment area 586 can be provided on both sides of the vehicle assembly 50 because the battery assembly 100 is fully supported between the outer surface of the frame rail 58A and the outer surface of the frame rail 58B.

By preserving the vehicle equipment area 586, the battery assembly 100 can facilitate mounting other vehicle equipment in the space provided. For example, downward hanging portions of a truck box or beverage body can extend into the vehicle equipment area 586 without obstruction from the battery assembly 100. Because the central portion 490 extends into the space between the frame rails 58 a large amount of battery storage is still possible. For applications requiring more storage, additional (e.g., second, third or more than three) battery assemblies 100 can be provided on the frame rails 58. The battery assembly 100 also provides a low profile battery management module 518. The battery management module 518 can be disposed at or below the elevation of the first shoulder 482 or second shoulder 498 such that the battery management module 518 can nest under a cross members 60 while still allowing the central portion 490 of the housing 400 to extend up toward and even to or in some cases over the top edge of the frame rails 58.

The battery assembly 100 thus provides a transversely compact assembly that enhances volume for storage of battery units 514 within a central area to accommodate large stacks of battery units inward of the inward facing sides of frame rails 58. As such, utility vehicles such as Class 5 and 6 trucks and other similar vehicles can be equipped to operate by the electric drivetrain system 98.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. A battery assembly for an electric vehicle, comprising:
a housing comprising a concave enclosure having a forward side, a rearward side, a top portion and a bottom side, an access plate being coupled with the bottom side,
the top portion comprising a first shoulder extending from a first lateral side of the concave enclosure toward a central portion of the concave enclosure, the first shoulder extending a first distance from the access plate, a second shoulder extending from a second lateral side of the concave enclosure toward the central portion, the second shoulder extending a second distance from the access plate,
the central portion extending from the first shoulder to the second shoulder and extending a third distance from the access plate, the third distance being greater than the first distance and the second distance;
one or more battery units disposed within the concave enclosure at an elevation above the first shoulder and an elevation above the second shoulder; and
a mounting system having a first portion disposed on the first shoulder and a second portion disposed on the second shoulder, the mounting system further comprising:
a frame member bracket configured to connect to a frame member of a vehicle; and
a shoulder bracket system comprising:
a load member having a first portion disposed over the first shoulder of the top portion of the concave enclosure and a second portion angled relative to the first portion, the second portion disposed along a lateral side of the central portion;
an aperture array disposed along the first lateral side of the concave enclosure, the aperture array configured to be coupled to the frame member bracket; and
a vibration isolator disposed between the load member and a top surface of the first shoulder to reduce load transmission from the frame member of the vehicle to the housing.

2. The battery assembly of claim 1, wherein the first distance and the second distance are approximately the same.

3. The battery assembly of claim 1, wherein the third distance is more than twice the first distance.

4. The battery assembly of claim 1, wherein an aspect ratio is defined as a ratio of the third distance to a width defined in a horizontal plane perpendicular to the third distance and perpendicular to a longitudinal axis of a vehicle to which the battery assembly is configured to be coupled exceeds 0.5.

5. The battery assembly of claim 1, further comprising a battery management module disposed on one of the forward side or the rearward side of the housing.

6. The battery assembly of claim 1, wherein the aperture array is located on a lateral extension of the load member.

7. The battery assembly of claim 6, wherein the lateral extension comprises a connection portion coupling the first portion of the load member to the second portion of the load member.

8. The battery assembly of claim 7, wherein the lateral extension comprises a frame member clearance portion disposed between the connection portion and the aperture array.

9. The battery assembly of claim 1, wherein the load member comprises an elevated portion disposed between a first compressible member of the vibration isolator and a second compressible member of the vibration isolator, the elevated portion transferring a connection load to the first portion of the load member.

10. A battery assembly for an electric vehicle, comprising:
a housing comprising a forward side, a rearward side, a bottom side, and a top portion configured to project into a space between adjacent frame rails and a lateral portion configured to extend under a bottom surface of one of the adjacent frame rails;
one or more battery units disposed within the top portion of the housing; and
a connector coupled with the housing, the connector configured to releasably couple with one of the adjacent frame rails.

11. The battery assembly of claim 10, wherein the housing comprises a central upward projection, a first shoulder, and a second shoulder, wherein each of the first shoulder and the second shoulder comprise a connector, the connectors each comprising a shoulder bracket disposed thereon, each shoulder bracket configured to couple with a frame member bracket.

12. The battery assembly of claim 10, further comprising a frame member bracket configured to connect to a frame member of a vehicle, the connector comprising a shoulder bracket releasably connectable to the frame member bracket between the top portion of the housing and an outer edge of the lateral portion of the housing.

13. The battery assembly of claim 12, wherein the shoulder bracket comprises a load member and a vibration isolator disposed between the load member and the housing, the vibration isolator, the load member, and the housing placed under compression to secure the load member and the vibration isolator to the housing.

14. The battery assembly of claim 12, wherein the shoulder bracket comprises a first portion disposed over the lateral portion and a second portion disposed along a lateral surface of the top portion, and further comprising a connection portion extending from the first portion to the second portion.

15. The battery assembly of claim 14, wherein the connection portion extends from the second portion of the shoulder bracket to an aperture array disposed at a lateral edge of the housing.

16. (canceled)

17. The battery assembly of claim 12, wherein the shoulder bracket comprises an aperture array disposed at a lateral edge of the lateral portion, the aperture array configured to connect with an inward facing side of the frame member bracket.

18. The battery assembly of claim 10, wherein the housing comprises a downward facing concave enclosure and an access plate coupled with a bottom side of the downward facing concave enclosure.

19. The battery assembly of claim 18, wherein the downward facing concave enclosure comprises one or more battery units disposed in the top portion at an elevation above the lateral portion.

20. The battery assembly of claim 10, wherein the housing comprises an inverted T-shape configuration.

21. The battery assembly of claim 10, wherein an aspect ratio of a height of the housing of the battery assembly to a width of the housing exceeds 0.5.

22. The battery assembly of claim 10, further comprising a battery management disposed within a portion of the housing having an upper surface disposed between an elevation of the lateral portion and the bottom side.

23. (canceled)

24. (canceled)

25. (canceled)

26. (canceled)

27. A vehicle assembly, comprising:
a frame assembly comprising a first frame rail having an inner surface facing toward a central longitudinal axis of the frame assembly and an outer surface facing away from the central longitudinal axis of the frame assembly, the frame assembly further comprising a second frame rail disposed on an opposite side of the central longitudinal axis of the frame assembly from the first frame rail, the second frame rail having an inner surface facing toward the central longitudinal axis of the frame assembly and an outer surface facing away from the central longitudinal axis of the frame assembly; and
a battery assembly, comprising:
a housing comprising a concave enclosure having a central portion disposed between and projecting from adjacent shoulder portions;
a first battery unit disposed within the central portion and a second battery unit disposed within one of the adjacent shoulder portions; and
a mounting system comprising:
a first frame member bracket coupled to the outer surface of the first frame rail;
a second frame member bracket coupled to the outer surface of the second frame rail;
a shoulder bracket system comprising:
a first load member having a first portion disposed over one of the adjacent shoulder portions and a second portion disposed along the central portion of the housing;
a vibration isolator disposed between the first load member and a top surface of the one of the adjacent shoulder portions;
a first aperture array disposed at or adjacent to a first lateral edge of the housing, the first aperture array coupled with the first frame member bracket;
a second load member having a first portion disposed over the other of the adjacent shoulder portions and a second portion disposed along the central portion of the housing;
a vibration isolator disposed between the second load member and a top surface of the other of the adjacent shoulder portions; and
a second aperture array disposed at or adjacent to a second lateral edge of the housing, the second aperture array coupled with the second frame member bracket;
wherein the first battery unit is disposed between the first frame rail and the second frame rail and the second battery unit is disposed below the first frame rail and the second frame rail.

28. The vehicle assembly of claim 27, wherein the first lateral edge of the housing is disposed inboard of the outer surface of the first frame rail and the second lateral edge of the housing is disposed inboard of the outer surface of the second frame rail.

29. The vehicle assembly of claim 28, further comprising vehicle equipment mounted to the first frame rail and/or the second frame rail at the same position along the central longitudinal axis of the vehicle assembly as is the battery assembly.

30. (canceled)

31. (canceled)

32. The vehicle assembly of claim 27, further comprising an axle drive assembly coupled with the frame assembly rearward of a cross-member and between the inner surface of the first frame rail and the inner surface of the second frame rail.

33. The vehicle assembly of claim 32, further comprising an accessory module electrically coupled to the battery assembly and the axle drive assembly coupled with the battery assembly, such that the accessory module and the axle drive assembly are powered by the same battery assembly.

34. The vehicle assembly of claim 33, further comprising a power distribution assembly disposed electrically between the battery assembly, the axle drive assembly and the accessory module.

35. (canceled)

36. (canceled)

37. The vehicle assembly of claim 27, wherein an aspect ratio is defined as a ratio of a height of the housing in a vertical direction to a width of the housing in a horizontal direction transverse to the central longitudinal axis of the frame assembly exceeds 0.5.
